(19) United States
(12) Patent Application Publication
(10) Pub. No.: US 2011/0192866 A1
(43) Pub. Date: Aug. 11, 2011

(54) Aggregate Material Feeder

(76) Inventor: Bruce Shaw, (US)

(21) Appl. No.: 12/703,200

(22) Filed: Feb. 10, 2010

(51) Int. Cl. B67D 7/06; B65D 88/66; B05B 7/00

(52) U.S. Cl. 222/185.1; 222/630; 222/196; 222/199

(57) ABSTRACT

The invention is an apparatus to more efficiency move aggregate material from a bulk shipping or storage container to a hot melt or intermediate tank. The apparatus allows the chips to flow from the shipping container into an enclosed chamber by means of a feed chute which opens close to the floor of the chamber so that, as the chips fall out of the feed chute onto the chamber floor, the chips form a pile of a predictable size. By raising or lowering the bottom end of the chute, the size of the pile is varied such that the outer edge of the chip pile reaches the chamber's exit portal, so the chips fall into the hot melt tank or a transportation system, taking the material to the hot melt tank with minimal bridging or complex instrumentation.

### B. CROSS-REFERENCE TO RELATED APPLICATIONS

None

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### BACKGROUND OF THE INVENTION

(1) Field of the Invention

The present invention pertains to the process of feeding aggregate materials into transport systems. Specifically, it addresses the process of replenishing heated tank systems with hot melt adhesives or plastic materials transported from bulk containers to those tanks where the materials are melted and dispensed, or intermediate tanks where material is kept ready until needed.

(2) Description of the Related Art Including Information Disclosed Under 37 CFR 1.97 and 1.98

Hot melt adhesive is solid at room temperature, but melts to a liquid or fluid state when heated, in which form they are applied to a substrate. On cooling, the adhesive regains its solid form. Popular forms in which hot melt adhesives are shipped include small pellets of various shapes, less than a quarter-inch square, and flat chips more than two square inches in area, as well as oval pastiles. In whichever form they are shipped, they must be transferred from a shipping container to a melting tank at a carefully controlled pace to create and maintain the fluid form until used. (For purposes of this document, “chips” will be used to denote the full panoply of possible forms.)

Hot melt adhesive is utilized by melting the chips in a heated container called a “hot melt pot”, “melt tank”, or “melter”. The tanks are often in difficult-to-reach locations because the melt tank must be kept located physically close to the point of application in a factory. Adhesive application systems must require sufficient space near the tank to store the unmelted chips, or provide for a transport system to continuously move the chips from storage to the melter.

Before automatic systems became commonplace, the chips were added to the tank by hand from smaller boxes of varying weights, but typically not more than 50 pounds. With those systems, the boxes were moved using factory workers who picked them up and carried them to the melt tanks. Sometimes a two-wheeled truck could be used. Back injuries and spilled chips were common. Factory workers struggled with timely material addition to the tanks, overcompensating by dumping too much unmelted material into the melter at one time after noticing that they had let the adhesive level in a melter get too low. This could lower the melt tank temperature quickly, further decreasing system production.

In recent years with more automated systems, users have automatic application systems, and prefer shipment larger containers, often 1500-pound bulk boxes or sacks. These larger containers are not easily moved within the confines of an automated factory floor, so users try to place the unwieldy shipping container and intermediate storage container in a convenient location, feeding the chips to various melt tanks throughout the factory.

Because of their chemical composition, hot melt chips can be gummy, tending to clump together easily. The hot melt adhesive industry is constantly searching for ways to prevent the materials from clumping together and blocking the suction device used to pull them out of the shipping container, also known as “bridging”. The columnar pressure caused by the weight of the material as it sits in the shipping container accentuates the tendency of the chips to clump together, which naturally increases with depth of the material. This columnar pressure causing jams in suction equipment, and is difficult to monitor with automatic equipment. Typical systems use vibration devices and air lances to reduce this jamming, but interruptions of material flow due to jams still occur often enough that users still complain and request better solutions.

The adhesive industry uses multiple approaches to solve the problem of moving the hot melt adhesive chips to the melt tank. These employ complex systems to avoid columnar pressure and the increased bridging that naturally occurs if material is pulled from the bottom of the shipping container.

U.S. Pat. No. 5,378,089 discloses one example of such a complex system. It includes a vibratory element to help reduce hot melt adhesive chip bridging, along with a pressurized air system for moving the chips to the melt tank through air-pressured piping. The rate of transfer is managed by a process control system that monitors the level of material in the melt tank. As the melted material is used, the control system notes the lowered level of material in the melting tank, which reacts by replenishing the tank with additional chips. The output of the system is limited by its capacity to process raw material by melting it in the tank without disrupting the state of the material already present in the tank and prepared for use.

One common approach uses an intermediate holding container into which the shipping container is slowly emptied. The benefit of this approach is that columnar pressure of the feed system to the melt tank is reduced to a more easily managed level than the much higher pressures generated at the bottom of a large shipping container.

Hot melt adhesive chips are pulled from the top of the shipping container and deposited in the intermediate tank. The intermediate tank, also known as a “sequester tank” or “storage tank” then dispenses material out portals in the side of the sequester tank to feed the transit system leading to the melt tank. Because the sequester tank has a lower material level, it has reduced columnar pressure in comparison to the main tank.

This approach has drawbacks, however. First, the level of this intermediate tank must be controlled with its own set of sensors and monitoring equipment, making the system more complex and costly. Second, the sequester tank uses additional factory floor space. Third, the user still has to fill the sequester tank from the shipping container in some manner. Typical approaches use piping and suction to withdraw from the shipping container at its top, which necessarily means that some of the chips will remain in the bottom of the shipping container unless a factory worker removes it manually or directs the suction wand to the corners and sides of the container to capture the material not initially withdrawn. It is common for factory workers to physically kick the box to loosen the chips from the corners and sides of the boxes.

Another approach used in the industry is to use a suction system to withdraw the raw material from a permanent storage bin or large box, directly feeding it to the melt tank as the level of the melt-tank dictates. The suction device can be combined with a vibrating element or air lance in an attempt to reduce jams by vibrating clumped material apart.

These systems still struggle with drawing from the top of the shipping container. The suction wand that is placed in the material often has a vibrating element and tends to travel through the middle of the container, failing to capture a significant portion of the raw material in the container unless manually directed by its operator. The vibrating element requires power to operate. This power can be air or electric, but in either case requires moving parts.

Yet a third method is to develop a permanent sequester bin into which adhesive chips are dumped. These permanent bins have installed ports located near the bottom of the bin, and draw from near the bottom with a permanent feed mechanism using vacuum. This approach fails in the market to realize its goal, as the units in the field are typically not operable because the performance fails to meet expectations, and the tanks cannot be filled as much as desired because the columnar pressure cannot be overcome by the suction. The end result is that these bins must be operated with much less material in them than factory workers desire, and the level of automation is hampered because the bin must be so closely monitored and refilled too often.

What is needed is a simple means to take raw materials from the storage container to their melt tanks in a manner that increases throughput, reduces bridging, requires less human management, increases reliability by keeping the number of moving parts to a minimum, decreases waste by increasing raw material capture from the container, and allows for ease of use and installation.

### BRIEF SUMMARY OF THE INVENTION

The general object of the invention is to efficiently transfer material from bulk containers in a controlled manner, particularly when that material is susceptible to bridging. In particular, the invention is a hopper that is fed with a chute whose exit end is located close to the floor of the hopper. This placement allows the material flowing through the chute to build up in a pile, blocking further flow until a portion of the pile is removed by a transport system.

The hopper reduces bridging by constructing the hopper so that the material piles on the floor of the hopper so the other edge of the pile reaches the transportation system, while ensuring that the material is under minimal pressure due to the material's weight on itself.

The hopper eliminates the need for expensive sensor systems, intermediate tanks that are needed in other systems, and constant human intervention to keep material flowing.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### BRIEF DESCRIPTION OF THE SEVERAL VIEWS OF THE DRAWING

The attached drawings are provided as a non-limiting example of the invention, specifically:

FIG. 1—Orthogonal view of the invention.

FIG. 2—A side view of the invention, including an optional hinged observation panel.

FIG. 3—A cut-away side view of the invention along cut-lines F-G of FIG. 1.

### DETAILED DESCRIPTION OF THE INVENTION

According to the present invention, the foregoing and other objects and advantages are attained by a hopper 11 that takes advantage of the angle of repose of the material that is flowing through the system, solving long standing needs in the industry.

When bulk granular materials are poured onto a horizontal surface, a conical pile will form. The internal angle between the horizontal surface on which the pile forms and the line from the edge of the pile to the highest point of the pile is known as the angle of repose and is related to the density, surface area and shapes of the particles, as well as the coefficient of friction of the material. Materials with a low angle of repose form flatter piles than materials with a high angle of repose.

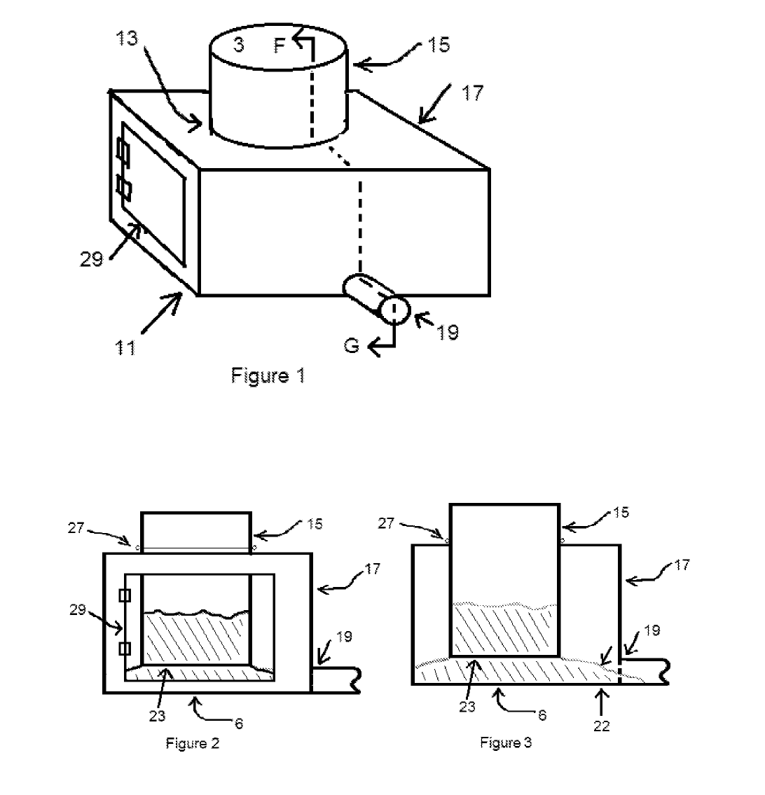

As seen in FIG. 1, the invention is a hopper 11 built to restrict flow of material and eliminate bridging. The hopper comprises a entrance portal 13 into which a feed chute 15 is vertically installed in the top of a typically enclosed receiving chamber 17, and a exit portal 19 that feeds a transit system 21 which carries material away from the hopper.

In the preferred embodiment, the feed chute 15 is a stainless steel tube with a diameter large enough to allow unfettered material flow. The lower opening of the chute 23 must be set so that material spilling out into the receiving chamber's floor 25 reaches the exit port 21, but does not cover the port entirely. Thus, the angle of repose 22 of the flow material controls how high the chute's lower opening 23 must be above the chamber floor 25. The chute's lower end 23 extends into the chamber 17 close enough to the floor 25 so that the material forms a pile extending high enough to stop further chip flow by plugging the lower end of the chute 23. Material then ceases to flow until some of the chips on the floor of the chamber 25 are removed to create space on the floor for additional material. In other words, the lower end of the feed tube 23 is positioned such that the pile of hot melt adhesive chips on the chamber floor 25 of the hopper prevents further movement until the chips which are already in the receiving chamber 17 and are fed out of the chamber, thus allowing room for more chips in the chamber's floor 25.

The exit portal 19 is at least large enough to allow the chips to flow out of the receiving chamber floor 25 to a transit system 21. One embodiment uses a 1.5″ opening in the side of the receiving chamber 17 with a PVC tube connected to it leading to an air-transit system. Other embodiments could include a conveyor belt to carry away the flow of material as it comes out at a controlled pace, as well as a hand scoop.

If the feed chute's lower end 23 is too close to the receiving chamber floor 25, the pile of hot melt adhesive chips escaping the feed chute will not reach the exit portal 19, and the system will fail to feed chips properly. If the feed chute's lower end 23 is too high from the chamber floor 25, too many hot melt adhesive chips will flood the chamber, covering the exit port 19, and columnar pressure can cause bridging and other problems that existing systems experience. Because hot melt adhesive chips come in various shapes, sizes, and materials, the correct height of the lower opening of the feed chute 23 will often require an adjustment when changing from one type of hot melt adhesive to another, so a means of easily changing the chute height is useful. FIGS. 2 and 3 include a hose clamp 27 for this function; pinch bolts have also been used.

A transparent observation panel 29 can be placed on any side of the receiving chamber to allow factory workers to check for proper material flow. One embodiment uses transparent plastic, but it could be made of glass or any material that would not chemically react with the flow material. The observation panel 29 could be constructed to be part of a hinged door 31, and placed on a side of the receiving chamber 17 closest to an exit portal 19, allowing a factory worker to see the material flow from the feed chute 15 into the chamber 17, and then ensure that the material level into the exit portal 19 is correct.

Thus, an essential element of the invention is to position the feed chute's bottom 23 at a height above the chamber floor 25 so that the material's angle of repose as it piles on the chamber floor 25 from the feed chute allows the material to flow easily into the exit portal 19.

Though the invention was developed for feeding hot melt adhesive chips, this same invention can be used to feed any similarly sized material which might not flow well through transport systems, including metal screws, plastic chips, etc.

### SEQUENCE LISTING

Not Applicable

1) A hopper for reliably dispensing aggregate material, comprising:
a. a receiving chamber having one or more entrance portals, one or more exit portals, and a floor structure, such that feed chute ends are maintained a consistent height from the receiving chamber floor and distance from the exit port(s); and,
b. one or more feed chutes with sufficient open cross-sectional area and diameter to allow free flow of material without bridging, mounted such that one end of each chute is outside the receiving chamber, and one end positioned inside the receiving chamber at a height above the receiving chamber floor such that material falling through the chute will create a pile large enough that the material on the outer part of the pile reaches one or more exit portals, but not create a pile so large that columnar pressure of the pile restricts chip flow into the exit portal; and,
c. said exit ports connectable to a vacuum or other transport system, located near or at the bottom of said receiving chamber.

2) An apparatus as in claim #1, with a means for adjusting the vertical height of feed chute(s) over the receiving chamber floor.

3) An apparatus as in claim #1, with the additional element of an observation panel in the receiving chamber.

4) An apparatus as in claim #1, with a door in the chamber.

5) An apparatus as in claim #1, with the addition of a vibrating element affixed to the receiving chamber.

6) An apparatus as in claim #1, with the additional limitations that the means for adjusting the height of the feed chute are pinch bolts, the feed chute is a 10″ pipe, the receiving chamber is enclosed, and the transport system uses an air-operated vacuum system to convey material away from the chamber.

7) An apparatus as in claim #1, with the additional limitation that the invention is used only for hot melt adhesives and plastics.
